(19) United States
(12) Patent Application Publication
(10) Pub. No.: US 2026/0161256 A1
(43) Pub. Date: Jun. 11, 2026

(54) TOUCH SENSING DISPLAY APPARATUS AND DRIVING METHOD THEREOF

(71) Applicant: LG Display Co., Ltd., Seoul (KR)

(72) Inventors: Seung Rok SHIN, Paju-si (KR); Deuk Su LEE, Paju-si (KR)

(21) Appl. No.: 19/405,018

(22) Filed: Dec. 1, 2025

(30) Foreign Application Priority Data
Dec. 5, 2024 (KR) 10-2024-0179543

(51) Int. Cl. G06F 3/044; G06F 3/041; G09G 3/3291

(52) U.S. Cl. CPC G06F 3/0446; G06F 3/0412; G06F 3/04164; G09G 3/3291; G09G 2300/0847; G09G 2320/0209; G09G 2320/0285

(57) ABSTRACT

A touch sensing display apparatus including a display panel including a plurality of pixels, a display driving circuit configured to output data voltages to data lines of the display panel, a touch screen panel disposed on the display panel and including first touch electrodes arranged in a first direction in which the data lines extend, second touch electrodes arranged in a second direction intersecting the first direction, first compensation electrodes respectively adjacent to the first touch electrodes, and second compensation electrodes respectively adjacent to the second touch electrodes, a touch circuit configured to drive the first and second touch electrodes to sense a touch input applied to each of touch sensors, and a compensation circuit configured to supply the first and second compensation electrodes with a compensation voltage for compensating for crosstalk caused by a variation of each of the data voltages while the touch input is being sensed.

### CROSS REFERENCE TO RELATED APPLICATION

This application claims priority from and the benefit of Korean Patent Application No. 10-2024-0179543, filed on Dec. 5, 2024, which is hereby incorporated by reference for all purposes as if fully set forth herein.

### BACKGROUND

### Field

Embodiments of the invention relate generally to a touch sensing display apparatus and a driving method thereof.

### Discussion of the Background

As thicknesses of display panels are reduced, a parasitic capacitance between data lines and a touch electrode increases. The parasitic capacitance may be modeled as a parasitic capacitor providing a path through which touch noise flows into a touch sensor. When the parasitic capacitor is relatively large, or a pattern of a data voltage is rapidly changed, crosstalk between a display and a touch may increase, and due to this, touch performance and display quality may be degraded.

The above information disclosed in this Background section is only for understanding of the background of the inventive concepts, and, therefore, it may contain information that does not constitute prior art.

### SUMMARY

A touch sensing display apparatus and a driving method thereof according to embodiments of the invention are capable of decreasing crosstalk between a display and a touch to improve touch performance and display quality.

Additional features of the inventive concepts will be set forth in the description which follows, and in part will be apparent from the description, or may be learned by practice of the inventive concepts.

According to one or more embodiments of the invention, a touch sensing display apparatus includes: a display panel including a plurality of pixels; a display driving circuit configured to output data voltages, which are for driving the plurality of pixels, to data lines of the display panel; a touch screen panel disposed on the display panel and including first touch electrodes arranged in a first direction in which the data lines extend, second touch electrodes arranged in a second direction intersecting the first direction, first compensation electrodes respectively adjacent to the first touch electrodes, and second compensation electrodes respectively adjacent to the second touch electrodes; a touch circuit configured to drive the first touch electrodes and the second touch electrodes to sense a touch input applied to each of touch sensors; and a compensation circuit configured to supply the first compensation electrodes and the second compensation electrodes with a compensation voltage for compensating for crosstalk caused by a variation of each of the data voltages while the touch input is being sensed.

The first compensation electrodes may be surrounded by the first touch electrodes, and the second compensation electrodes may be surrounded by the second touch electrodes.

The compensation voltage may be an alternating current (AC) voltage which varies at a period of one horizontal period assigned for driving of pixels disposed in one pixel row, and the compensation voltage and the data voltages may vary with phases opposite to each other.

The compensation voltage applied to each of the first and second compensation electrodes is generated using a weighted look-up table.

The first compensation electrodes and the second compensation electrodes may be divided into a plurality of compensation units separated from each other in the second direction, and the first compensation electrodes and the second compensation electrodes included in a same compensation unit may be electrically short-circuited with each other and supplied with a same compensation voltage.

One of the compensation units may be electrically disconnected from another compensation unit and independently supplied with a compensation voltage.

The data lines may be divided into a plurality of groups corresponding to the plurality of compensation units, and one compensation unit included in the plurality of compensation units may overlap data lines of one group among the plurality of groups.

In a predetermined time period, a variation direction of a compensation voltage supplied to the one compensation unit is opposite to an average variation direction of data voltages supplied to the data lines of the one group.

In a same compensation unit, each of the first compensation electrodes may include a plurality of first sub compensation electrodes electrically connected to each other, and each of the second compensation electrodes may include a plurality of second sub compensation electrodes electrically connected to each other.

Each of the first touch electrodes, the second touch electrodes, the first compensation electrodes, and the second compensation electrodes may include conductive mesh patterns.

A bank pattern for defining emission regions of the pixels may be included in the display panel, and the conductive mesh patterns avoid the emission regions and overlap the bank pattern.

The display panel may further include a cathode electrode disposed on the data lines and connected to the pixels in common. With respect to one of touch sensors, a parasitic capacitance between the first compensation electrode and the cathode electrode may be substantially 50% or more of a parasitic capacitance between the cathode electrode and data lines overlapping a first touch electrode region. With respect to one of the touch sensors, a parasitic capacitance between the first compensation electrode and the first touch electrode may be 30% or less of a parasitic capacitance between the cathode electrode and the first touch electrode.

An overlap area of the first compensation electrode with the first touch electrode may be smaller than an overlap area of the first touch electrode with the cathode electrode.

With respect to one of touch sensors, a parasitic capacitance between the second compensation electrode and the cathode electrode may be substantially 50% or more of a parasitic capacitance between the cathode electrode and data lines overlapping a second touch electrode region. With respect to one of the touch sensors, a parasitic capacitance between the second compensation electrode and the second touch electrode may be substantially 30% or less of a parasitic capacitance between the cathode electrode and the second touch electrode.

An overlap area of the second compensation electrode with the second touch electrode may be smaller than an overlap area of the second touch electrode with the cathode electrode.

A distance between one of the first and second touch electrodes and the cathode electrode may be greater than a distance between the cathode electrode and the data line. In particular, the distance between one of the first and second the touch electrodes and the cathode electrode may be greater than or equal to twice the distance between the cathode electrode and the data line.

According to yet another embodiment of the invention, a driving method of a touch sensing display apparatus, including a display panel, includes a plurality of pixels and a touch screen panel disposed on the display panel and including first touch electrodes arranged in a first direction in which the data lines extend and second touch electrodes arranged in a second direction intersecting the first direction, includes: outputting data voltages, which are for driving the plurality of pixels, to data lines of the display panel; driving the first touch electrodes and the second touch electrodes to sense a touch input applied to touch sensors; and supplying a compensation voltage, which is for compensating for crosstalk caused by a variation of each of the data voltages, to first and second compensation electrodes respectively adjacent to the first and second touch electrodes while the touch input is being sensed, on the touch screen panel. The compensation voltage and the data voltage may vary with phases opposite to each other.

The first compensation electrodes may be surrounded by the first touch electrodes, and the second compensation electrodes may be surrounded by the second electrodes.

The compensation voltage may be an alternating current (AC) voltage which varies at a period of one horizontal period assigned for driving of pixels disposed in one pixel row.

The compensation voltage for each of the first and second compensation electrodes may be generated using a weighted look-up table.

The first compensation electrodes and the second compensation electrodes may be divided into a plurality of compensation units separated from each other in the second direction, and the first compensation electrodes and the second compensation electrodes included in a same compensation unit may be electrically short-circuited with each other and supplied with a same compensation voltage.

A compensation unit may be electrically disconnected from another compensation unit and independently supplied with a compensation voltage.

According to yet another embodiment of the invention, a touch sensing display apparatus includes a display panel including a plurality of pixels and a plurality of data lines; and a touch screen panel is disposed on the display panel. The touch screen panel includes: first touch electrodes disposed above the data lines and arranged in a first direction in which the data lines extend; second touch electrodes disposed above the data lines and arranged in a second direction intersecting the first direction; and first additional electrodes respectively adjacent to the first touch electrodes, and second additional electrodes respectively adjacent to the second touch electrodes.

The first additional electrodes may be surrounded by the first touch electrodes, and the second additional electrodes may be surrounded by the second touch electrodes.

With respect to one of touch sensors, a parasitic capacitance between the first additional electrode and the cathode electrode may be substantially 50% or more of a parasitic capacitance between the cathode electrode and data lines overlapping a first touch electrode region. With respect to one of the touch sensors, a parasitic capacitance between the first additional electrode and the first touch electrode may be substantially 30% or less of a parasitic capacitance between the cathode electrode and the first touch electrode.

An overlap area of the first additional electrode with the first touch electrode is smaller than an overlap area of the first touch electrode with the cathode electrode.

With respect to one of touch sensors, a parasitic capacitance between the second additional electrode and the cathode electrode may be substantially 50% or more of a parasitic capacitance between the cathode electrode and data lines overlapping a second touch electrode region. With respect to one of the touch sensors, a parasitic capacitance between the second additional electrode and the second touch electrode may be substantially 30% or less of a parasitic capacitance between the cathode electrode and the second touch electrode.

An overlap area of the second additional electrode with the second touch electrode is smaller than an overlap area of the second touch electrode with the cathode electrode.

Each of the first touch electrodes, the second touch electrodes, the first additional electrodes, and the second additional electrodes may include conductive mesh patterns.

Each of the first and second additional electrodes may include a plurality of sub compensation electrodes electrically connected to each other.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the inventive concepts.

FIG. 1 is a diagram schematically illustrating a touch sensing display apparatus according to an embodiment of the invention.

FIG. 2A and FIG. 2B are diagrams illustrating an example where a touch electrode layer is coupled to a display electrode layer through a cathode electrode layer.

FIG. 3 is a diagram illustrating crosstalk between a display and a touch with respect to a display image pattern.

FIG. 4 is an exploded perspective diagram illustrating an implementation example of a compensation unit.

FIG. 5 is a diagram illustrating an example where first compensation electrodes and second compensation electrodes configuring the compensation unit of FIG. 4 are electrically connected to each other.

FIG. 6 is a diagram illustrating an example where each of a plurality of compensation units are independently supplied with a compensation voltage.

FIG. 7 is a diagram illustrating another implementation example of a compensation unit.

FIG. 8 is a diagram illustrating an example where first compensation electrodes and second compensation electrodes configuring the compensation unit of FIG. 7 are electrically connected to each other.

FIG. 9 is a diagram illustrating an example where each of first and second touch electrodes and first and second compensation electrodes is implemented with a conductive mesh pattern.

FIG. 10 is a cross-sectional view taken along line A-A′ of FIG. 9 according to an embodiment.

FIG. 11 is a cross-sectional view taken along line B-B′ of FIG. 9 according to an embodiment.

FIG. 12 is a diagram illustrating an implementation example where a compensation electrode and a compensation pad are electrically connected to each other through a compensation routing line.

FIG. 13 and FIG. 14 are diagrams illustrating an implementation configuration example of a compensation circuit.

FIG. 15 is a flow chart illustrating an implementation operation example of a compensation circuit.

FIG. 16 is a waveform diagram illustrating an example where a data voltage and a compensation voltage vary with phases opposite to each other.

### DETAILED DESCRIPTION

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are shown in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z - axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of idealized embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As is customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the inventive concepts. Further, the blocks, units, and/or modules of some embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

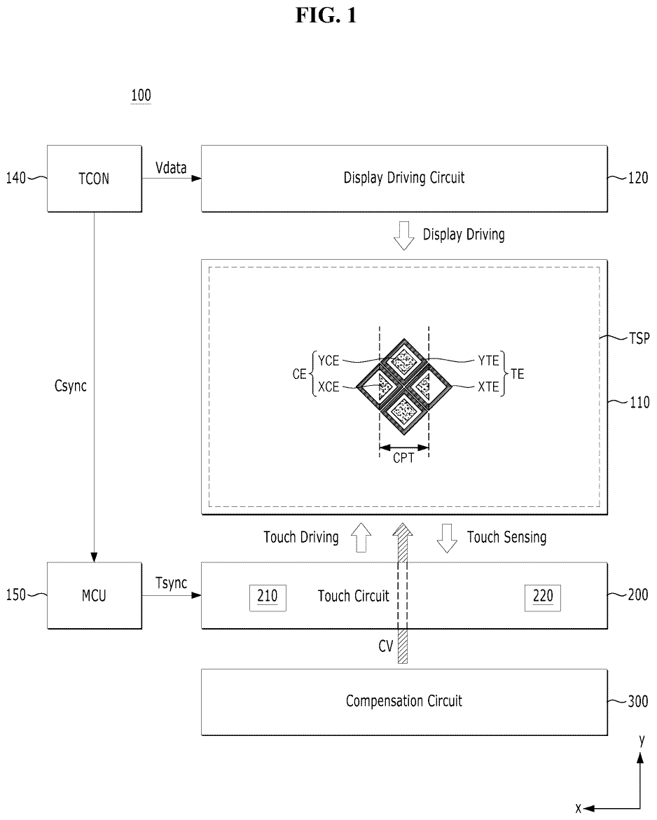

FIG. 1 is a diagram schematically illustrating a touch sensing display apparatus 100 according to an embodiment of the invention.

Referring to FIG. 1, the touch sensing display apparatus 100 according to an embodiment of the invention may provide a display function for displaying an input image on a screen, a touch sensing function for sensing a touch input of a user, and a crosstalk compensation function for reducing crosstalk between a display and a touch.

The touch sensing display apparatus 100 may include a display panel 110 where data lines and gate lines are disposed, and a display driving circuit 120 for driving the display panel 110, so as to implement the display function.

The display panel 110 may be implemented either as a liquid crystal display (LCD) panel or an organic light emitting display (OLED) display. The illustrated embodiment describes an example where the display panel 110 is implemented as the OLED panel, but the inventive concepts are not limited thereto, and may be applied to the LCD panel.

The display panel 110 may include a plurality of pixels. Each of the pixels may be implemented with a pixel circuit which is connected to a data line and a gate line through a thin film transistor (TFT). The pixel circuit may include a light emitting device, a driving transistor, one or more switching transistors, and a capacitor. The light emitting device may be implemented as an organic light emitting diode (OLED) where an organic compound layer is disposed between a cathode electrode and an anode electrode. A driving current applied to the light emitting device may be controlled based on a gate-source voltage of the driving transistor. The gate-source voltage of the driving transistor may be determined by a data voltage corresponding to input image data.

The display driving circuit 120 may include a data driving circuit which supplies data voltages to the data lines of the display panel 110, a gate driving circuit which supplies gate signals to the gate lines of the display panel 110, and a timing controller (TCON) 140 for controlling the data driving circuit and the gate driving circuit. The display driving circuit 120 may be implemented with one or more integrated circuits (ICs).

The touch sensing display apparatus 100 may include a touch screen panel TSP where a plurality of touch electrodes TE are disposed, and a touch circuit 200 which drives the touch screen panel TSP, so as to implement the touch sensing function.

The touch electrodes TE disposed in the touch screen panel TSP may include first touch electrodes YTE arranged in a first direction y, which is an extension direction of the data lines of the display panel 110, and second touch electrodes XTE arranged in a second direction x intersecting the first direction y. A plurality of touch sensors may be implemented by the first touch electrodes YTE and the second touch electrodes XTE.

The touch screen panel TSP may be an external type which is manufactured separately from the display panel 110 and is bonded to the display panel 110, or may be an internal type which is manufactured along with the display panel 110 and is disposed at an upper portion of the display panel 110. The illustrated embodiment may be based on a touch screen panel TSP of internal type, but is not limited thereto.

The touch circuit 200 may include a touch driver 210 which supplies a touch driving signal to the touch screen panel TSP, and a touch sensing unit 220 which receives a touch sensing signal from the touch screen panel TSP. The touch circuit 200 may drive the first touch electrodes YTE and the second touch electrodes XTE to sense a touch input applied to the touch sensors.

The touch driver 210 may supply the touch driving signal to the second touch electrodes XTE through second touch routing lines. The touch sensing unit 220 may receive a touch sensing signal from each of the first touch electrodes YTE to calculate a capacitance variation of each of the touch sensors and based thereon, may detect whether there is a touch input and coordinate information about a touched position.

The touch circuit 200 may be implemented as one or more components and may be implemented separately from the display driving circuit 120. Also, all or a portion of the touch circuit 200 may be implemented to be integrated with the display driving circuit 120 or an internal circuit thereof. For example, a portion of the touch circuit 200 may be implemented as an IC along with a data driving circuit of the display driving circuit 120.

The touch sensing display apparatus 100 may include compensation electrodes CE disposed in the touch screen panel TSP, and a compensation circuit 300 for driving the compensation electrodes CE, so as to implement a crosstalk compensation function.

The compensation electrodes CE disposed in the touch screen panel TSP may include first compensation electrodes YCE respectively adjacent to the first touch electrodes YTE and second compensation electrodes XCE respectively adjacent to the second touch electrodes XTE. The compensation electrode CE may be electrically disconnected from the touch electrode TE. For example, as shown in FIG. 1, the first compensation electrodes YCE may be respectively surrounded by the first touch electrodes YTE and the second compensation electrodes XCE may be respectively surrounded by the second touch electrodes XTE. As used herein, the term “surrounded by” with respect to an electrode (e.g., a compensation electrode) and a corresponding touch electrode is intended to encompass not only a case where the compensation electrode is disposed entirely within an opening of the touch electrode, but also a case where the compensation electrode is disposed adjacent to and substantially encircled by a pattern of the touch electrode.

While the touch circuit 200 is sensing a touch input, the compensation circuit 300 may supply the first compensation electrodes YCE and the second compensation electrodes XCE with a compensation voltage CV for compensating for crosstalk caused by a variation of data voltages supplied to data lines.

The first compensation electrodes YCE and the second compensation electrodes XCE may be divided into a plurality of compensation units CPT separated from one another in the second direction x. The first compensation electrodes YCE and the second compensation electrodes XCE included in the same compensation unit may be electrically connected to each other.

Each of the plurality of compensation units CPT may be connected to the compensation circuit 300 through an individual compensation routing line. The compensation circuit 300 may supply, through the compensation routing line, the same compensation voltage to the first compensation electrodes YCE and the second compensation electrodes XCE included in the same compensation unit.

The touch sensing display apparatus 100 may include a micro control unit (MCU) 150 which controls the touch circuit 200 and the compensation circuit 300. The micro control unit 150 may be supplied with a control synchronization signal Csync from the timing controller 140 to generate a touch synchronization signal Tsync for controlling the touch circuit 200 and the compensation circuit 300.

The micro control unit 150 may transfer the touch synchronization signal Tsync, based on an interface defined between the touch circuit 200 and the compensation circuit 300. The micro control unit 150 may be configured as one IC along with a touch controller of the touch circuit 200, or may be configured as one IC along with the timing controller 140.

The timing controller (TCON) 140 may control the display driving circuit 120 and the micro control unit 150. The timing controller 140 may be supplied with a data signal of an input image and a timing synchronization signal, such as a vertical synchronization signal, a horizontal synchronization signal, a data enable signal, and a dot clock, from a host system.

The timing controller 140 may be connected to the display driving circuit 120 through an internal interface. The timing controller 140 may transfer a data signal Vdata of an input image to the display driving circuit 120. The timing controller 140 may control a gate driving timing of the display driving circuit 120, based on a scan timing control signal, such as a gate start pulse, a gate shift clock, and a gate output enable signal. Also, the timing controller 140 may control a data driving timing of the display driving circuit 120, based on a data timing control signal, such as a source sampling clock and a source output enable signal.

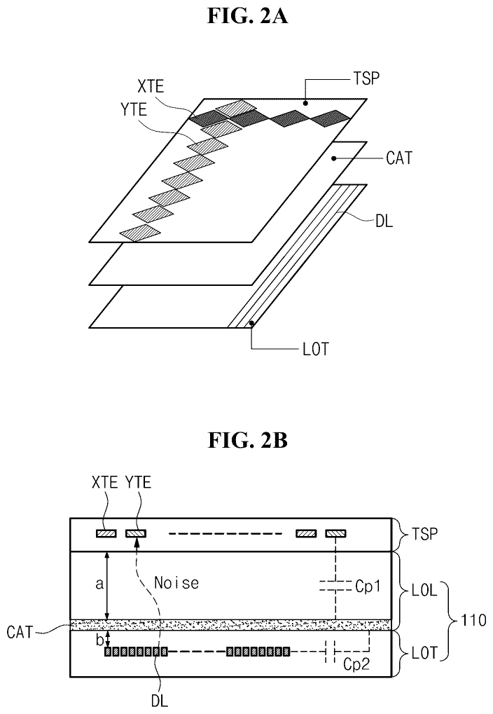

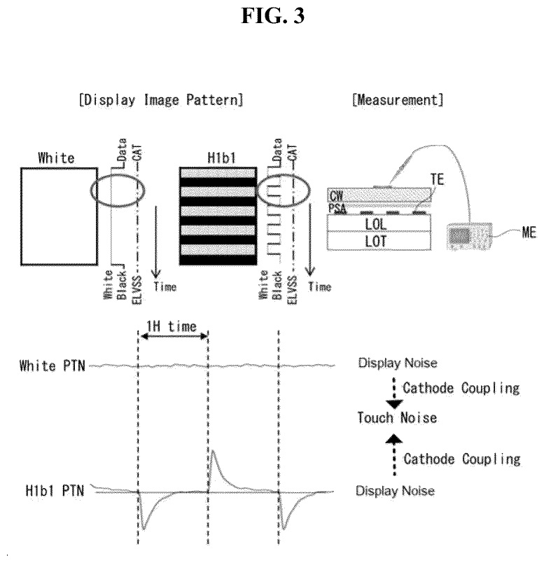

FIGS. 2A and 2B are diagrams illustrating an example where a touch electrode layer is coupled to a display electrode layer through a cathode electrode layer.

Referring to FIGS. 2A and 2B, a touch screen panel TSP may be disposed on a display panel 110 in an on-cell type or an add-on type. The display panel 110 may include an emission array layer LOL and a TFT array layer LOT for pixel implementation. Data lines DL may be included in the TFT array layer LOT.

Touch electrodes XTE and YTE configuring a touch sensor may be electrically coupled to the TFT array layer LOT through the emission array layer LOL. The emission array layer LOL may include a cathode electrode CAT of an OLED connected to a low-level pixel power, and the cathode electrode CAT may function as a common electrode shared by all pixels. As shown in FIG. 2B, the distance “a” between touch electrodes XTE, YTE and the cathode electrode CAT may be greater than the distance “b” between the cathode electrode CAT and the data lines DL. In an embodiment of the invention, the distance “a” may be greater than or equal to twice the distance “b”.

The cathode electrode CAT may function as a medium for noise inflow. The cathode electrode CAT may be electrically coupled to the touch electrodes XTE and YTE through a first parasitic capacitor Cp1 and may be electrically coupled to data lines DL through a second parasitic capacitor Cp2. Accordingly, display noise caused by a variation of a data voltage may flow into the touch sensor through the first and second parasitic capacitors Cp1 and Cp2. Each of the first and second parasitic capacitors Cp1 and Cp2 may provide a noise inflow path.

FIG. 3 is a diagram illustrating crosstalk between a display and a touch with respect to a display image pattern.

Referring to FIG. 3, in a display apparatus according to an embodiment of the invention, a touch screen panel including touch electrodes TE may be protected by a cover window CW. The cover window CW may be attached to the touch screen panel through an adhesive layer PSA. When a measurer ME measures noise in contact with one conductive pattern of the cover window CW, it may be seen that a magnitude of the noise flowing into the touch sensor is changed based on a display image pattern.

Display noise occurring in data lines DL may increase more in a white-black alternating pattern (Horizontal one-by-one, H1b1) than in a white image pattern (White PTN). Such display noise may affect a touch sensing signal through cathode coupling. Therefore, touch noise caused by the cathode coupling may increase to a greater degree in the white-black alternating pattern (Horizontal one-by-one, H1b1) than in the white image pattern (White PTN).

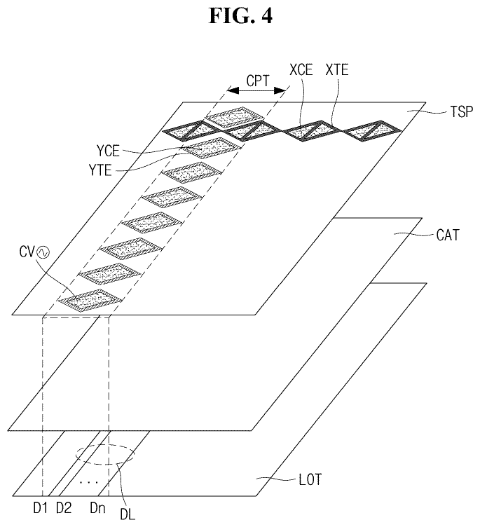

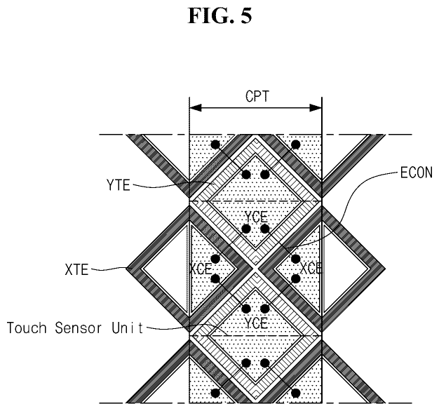

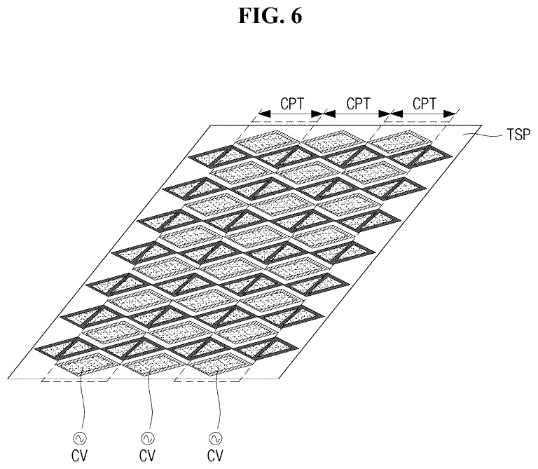

FIG. 4 is an exploded perspective diagram illustrating an implementation example of a compensation unit. FIG. 5 is a diagram illustrating an example where first compensation electrodes and second compensation electrodes configuring the compensation unit of FIG. 4 are electrically connected to each other. FIG. 6 is a diagram illustrating an example where each of a plurality of compensation units is independently supplied with a compensation voltage.

Referring to FIGS. 4 to 6, compensation units CPT may be used for compensating for crosstalk caused by a variation of data voltages supplied to data lines DL. Each of the compensation units CPT may be disposed to overlap n (where n may be a natural number of 2 or more) number of data lines D1 to Dn, and thus, may compensate for an average variation of data voltages on the data lines D1 to Dn.

In a compensation unit CPT overlapping the data lines D1 to Dn, first compensation electrodes YCE may be disposed on the same plane as first touch electrodes YTE, and may be respectively disposed adjacent to the first touch electrodes YTE or surrounded by the first touch electrodes YTE. In the compensation unit CPT, second compensation electrodes XCE may be disposed on the same plane as second touch electrodes XTE, and may be respectively disposed adjacent to the second touch electrodes XTE or surrounded by the second touch electrodes XTE.

In the compensation unit CPT, the first compensation electrodes YCE may be electrically connected to the second compensation electrodes XCE through connection electrodes ECON, as shown in FIG. 5.

In the compensation unit CPT, the connection electrodes ECON may be disposed on a plane different from a plane on which the first and second compensation electrodes YCE and XCE are disposed, and may be connected to the first and second compensation electrodes YCE and XCE through a contact hole passing through an insulation layer. Each of the connection electrodes ECON may connect the first compensation electrode YCE and the second compensation electrode XCE, which are disposed adjacent to each other with the first and second compensation electrodes YCE and XCE therebetween.

In the compensation unit CPT, the first and second compensation electrodes YCE and XCE may be short-circuited with each other through the connection electrodes ECON. A compensation circuit may supply the same compensation voltage CV (FIG. 6) to the first and second compensation electrodes YCE and XCE included in the compensation unit CPT. The compensation voltage CV may be used for compensating for an average variation of data voltages on the data lines D1 to Dn overlapping each other.

The compensation voltage CV may be an alternating current (AC) voltage which varies with a cycle of one horizontal period assigned for driving of pixels disposed in one pixel row. In particular, the compensation voltage CV may be an AC voltage which varies with a phase opposite to an average variation of data voltages on the data lines D1 to Dn. One pixel row may be a set of pixels which are arranged in parallel in a second direction x and are connected to the same gate lines. One horizontal period may be a time period obtained by dividing one frame period by a vertical resolution.

Moreover, n number of data lines D1 to Dn may correspond to each of the compensation units CPT. To this end, data lines may be grouped in a unit of n data lines. The number of groups of data lines may be equal to the number of compensation units CPT.

The compensation units CPT may be configured to be electrically disconnected from each other, and each compensation unit CPT may be independently supplied with the compensation voltage CV. The compensation voltages CV applied to the compensation units CPT may be equal to one another, or may differ. Each compensation unit CPT may be supplied with the compensation voltage CV from the compensation circuit through an individual compensation routing line.

The compensation units CPT may be separated from each other in a second direction x and may have a length in a first direction y and a width in a second direction x. A width of each compensation unit CPT may be equal to that of a touch sensor unit. An area of a touch sensor unit may be implemented to be a sum of an area of one first touch electrode YTE and an area of one second touch electrode XTE.

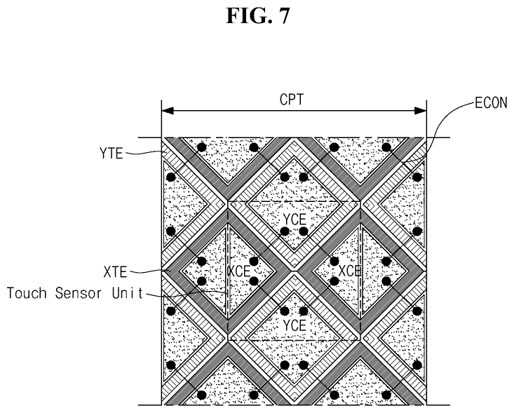

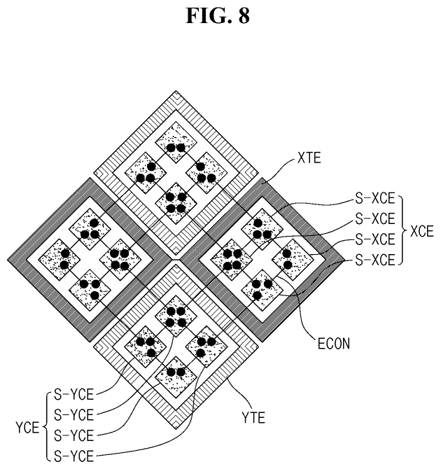

FIG. 7 is a diagram illustrating another implementation example of a compensation unit. FIG. 8 is a diagram illustrating an example where first compensation electrodes and second compensation electrodes configuring the compensation unit of FIG. 7 are electrically connected to each other.

Referring to FIGS. 7, 2n number of data lines D1 to D2n may correspond to each of compensation units CPT. To this end, data lines may be grouped in a unit of 2n data lines. The number of groups of data lines may be equal to the number of compensation units CPT.

The compensation units CPT may be separated from each other in a second direction x and may have a length in a first direction y and a width in a second direction x. A width of each compensation unit CPT may be two times a width of a touch sensor unit. An area of a touch sensor unit may be implemented to be a sum of an area of one first touch electrode YTE and an area of one second touch electrode XTE.

Referring to FIG. 8, in the same compensation unit CPT, each of first compensation electrodes YCE may include a plurality of first sub compensation electrodes S-YCE which are electrically connected to each other, and each of second compensation electrodes XCE may include a plurality of second sub compensation electrodes S-XCE which are electrically connected to each other.

The first sub compensation electrodes S-YCE may be surrounded by a first touch electrode YTE. The first sub compensation electrodes S-YCE may be arranged apart from one another at a certain interval, and adjacent first sub compensation electrodes S-YCE may be connected to each other through a connection electrode ECON.

The second sub compensation electrodes S-XCE may be surrounded by a second touch electrode XTE. The second sub compensation electrodes S-XCE may be arranged apart from one another at a certain interval, and adjacent second sub compensation electrodes S-XCE may be connected to each other through the connection electrode ECON.

Moreover, a first sub compensation electrode S-YCE and a second sub compensation electrode S-XCE which are disposed adjacent to each other with first and second touch electrodes YTE and XTE therebetween may be connected to each other through the connection electrode ECON.

In a compensation unit CPT, a real area of a compensation electrode may be less in FIG. 8 than in FIG. 7. Comparing with FIG. 7, the compensation unit CPT exemplarily illustrated in FIG. 8 may facilitate an adjustment of a real area of a compensation electrode, and thus, it is easy to control a magnitude of a parasitic capacitor connected to a compensation electrode.

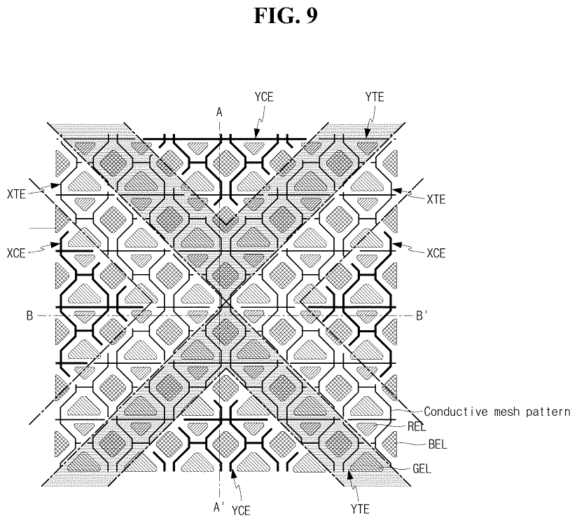

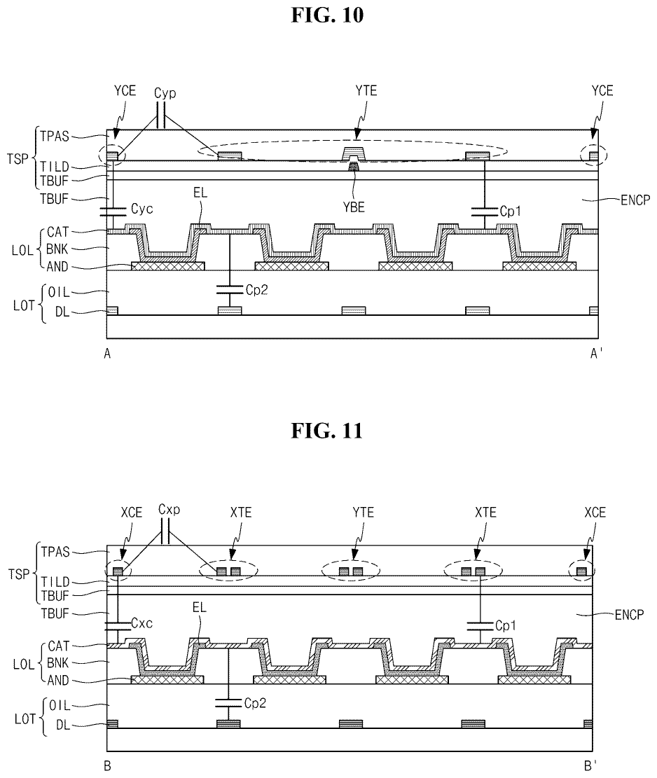

FIG. 9 is a diagram illustrating an example where each of first and second touch electrodes and first and second compensation electrodes is implemented with a conductive mesh pattern. FIG. 10 is a cross-sectional view taken along line A-A′ of FIG. 9 according to an embodiment. FIG. 11 is a cross-sectional view taken along line B-B′ of FIG. 9 according to an embodiment.

Referring to FIGS. 9 to 11, a touch sensing display apparatus according to an embodiment of the invention may display an image on a screen of a display panel through a plurality of pixels during a display period, and may sense a variation of a mutual capacitance based on a touch input of a user during a touch period to sense whether there is a touch input and a touched position. The touch sensing display apparatus according to an embodiment of the invention may supply a compensation voltage to first and second compensation electrodes YCE and XCE configuring a compensation unit during the touch period, thereby reducing noise caused by crosstalk between a display and a touch.

The display period and the touch period may partially overlap or fully overlap each other.

Each pixel may include an emission array layer LOL, including a light emitting device AND, EL, and CAT, a bank BNK, and an encapsulation layer ENCP, and a TFT array layer LOT including at least one TFT insulation layer OIL and data lines DL.

The light emitting device AND, EL, and CAT may include an emission stack EL and an anode electrode AND patterned to be separated from each other by pixel units, and a cathode electrode CAT shared by all pixels.

The bank BNK may define an opening region (or an emission region) of each of the pixels. The bank BNK may radially surround the opening region where the emission stack EL is formed. The bank BNK may be formed of an opaque material (for example, black) to prevent light interference between adjacent pixels. In this case, the bank BNK may include a light blocking material including at least one of a color pigment, organic black, and carbon.

The encapsulation layer ENCP may prevent external water or oxygen from penetrating into the light emitting device AND, EL, and CAT vulnerable to water or oxygen. To this end, the encapsulation layer ENCP may include an at least one-layer inorganic encapsulation layer and an at least one-layer organic encapsulation layer.

A touch screen panel TSP may be formed on the encapsulation layer ENCP.

The touch screen panel TSP may include a touch buffer layer TBUF, an electrode array layer, and a touch protection layer TPAS.

The touch buffer layer TBUF may be disposed on the encapsulation layer ENCP. In some embodiments, the touch buffer layer TBUF may be bonded to the encapsulation layer ENCP. The electrode array layer may be disposed on the touch buffer layer TBUF. The electrode array layer may include first and second touch electrodes YTE and XTE and first and second compensation electrodes YCE and XCE, which are disposed on an interlayer insulation layer TILD. The electrode array layer may further include a bridge electrode YBE disposed under the interlayer insulation layer TILD. The bridge electrode YBE may electrically connect adjacent first compensation electrodes YCE with each other.

Each of the first and second touch electrodes YTE and XTE and the first and second compensation electrodes YCE and XCE may be implemented with conductive mesh patterns. The conductive mesh patterns may be formed as a mesh type by using an at least one-layer conductive layer of titanium (Ti), aluminum (Al), molybdenum (Mo), molybdenum titanium (MoTi), copper (Cu), tantalum (Ta), and indium tin oxide (ITO), which have a higher conductivity than a transparent conductive layer.

The conductive mesh patterns may be formed in a three-layer structure, such as Ti/Al/Ti, MoTi/Cu/MoTi, or Ti/Al/Mo. Accordingly, the first and second touch electrodes YTE and XTE and the first and second compensation electrodes YCE and XCE may decrease in resistance and capacitance, and thus, touch sensitivity may be enhanced.

The conductive mesh patterns may be disposed in the electrode array layer to avoid opening regions overlap the bank BNK, and have a line width which is very thin, thereby preventing an aperture ratio and a transmittance from being reduced by the conductive mesh patterns.

Referring to FIG. 10, a first compensation parasitic capacitor Cyc may be formed between a first compensation electrode YCE and a cathode electrode CAT. The first compensation parasitic capacitor Cyc may function as a path for compensating for a voltage ripple of the cathode electrode CAT, and to this end, the capacitance value thereof may be relatively large. With respect to one of touch sensors, the first compensation parasitic capacitor Cyc may have a capacitance value which is substantially 50% or more of a parasitic capacitor Cp2 between the cathode electrode CAT and data lines DL overlapping a first touch electrode YTE region.

A first peripheral parasitic capacitor Cyp may be formed between the first compensation electrode YCE and the first touch electrode YTE. The first peripheral parasitic capacitor Cyp may be coupling between the first compensation electrode YCE and the first touch electrode YTE, and thus, the capacitance value thereof may be relatively small. The first peripheral parasitic capacitor Cyp may have a capacitance value which is substantially 30% or less of a parasitic capacitor Cp1 between the cathode electrode CAT and the first touch electrode YTE. For example, an overlap area of the first compensation electrode YCE with the first touch electrode YTE may be smaller than an overlap area of the first touch electrode YTE with the cathode electrode CAT.

Referring to FIG. 11, a second compensation parasitic capacitor Cxc may be formed between a second compensation electrode XCE and a cathode electrode CAT. The second compensation parasitic capacitor Cxc may function as a path for compensating for a voltage ripple of the cathode electrode CAT, and to this end, a capacitance value thereof may be relatively large. With respect to one of touch sensors, the second compensation parasitic capacitor Cxc may have a capacitance value which is substantially 50% or more of a parasitic capacitor Cp2 between the cathode electrode CAT and data lines DL overlapping a second touch electrode XTE region.

A second peripheral parasitic capacitor Cxp may be formed between the second compensation electrode XCE and the second touch electrode XTE. The second peripheral parasitic capacitor Cxp may be coupling between the second compensation electrode XCE and the second touch electrode XTE, and thus, a capacitance value thereof may be relatively small. The second peripheral parasitic capacitor Cxp may have a capacitance value which is substantially 30% or less of a parasitic capacitor Cp1 between the cathode electrode CAT and the second touch electrode XTE. For example, an overlap area of the second compensation electrode XCE with the second touch electrode XTE may be smaller than an overlap area of the second touch electrode XTE with the cathode electrode CAT.

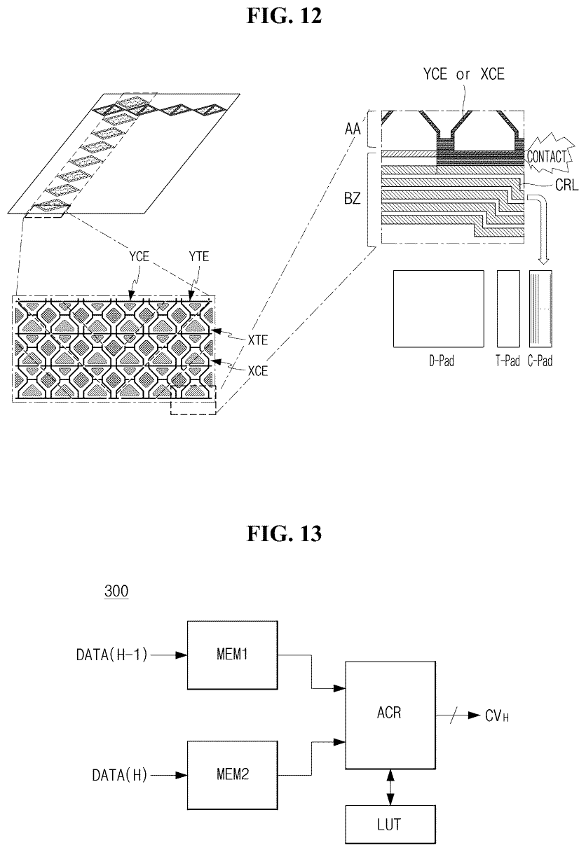

FIG. 12 is a diagram illustrating an implementation example where a compensation electrode and a compensation pad are electrically connected to each other through a compensation routing line.

Referring to FIG. 12, a bezel region BZ may be disposed in at least one side of an active area AA where touch electrodes YTE and XTE and compensation electrodes YCE and XCE are disposed. The bezel region BZ may include a bending region which enables a substrate to be bent or folded. A crack prevention layer may be further provided in the bending region so that the bending region is easily bent.

Display pads D-Pad connected to data lines, touch pads T-Pad connected to touch routing lines, and compensation pads C-Pad connected to compensation routing lines CRL may be disposed in the bezel region BZ.

The compensation electrodes YCE and XCE may contact the compensation routing lines CRL and may be connected to the compensation pads C-Pad through the compensation routing lines CRL. The compensation pads C-Pad may output a compensation voltage, varying in a unit of one horizontal period, to the compensation routing lines CRL. The compensation pads C-Pad may be connected to an output terminal of a compensation circuit.

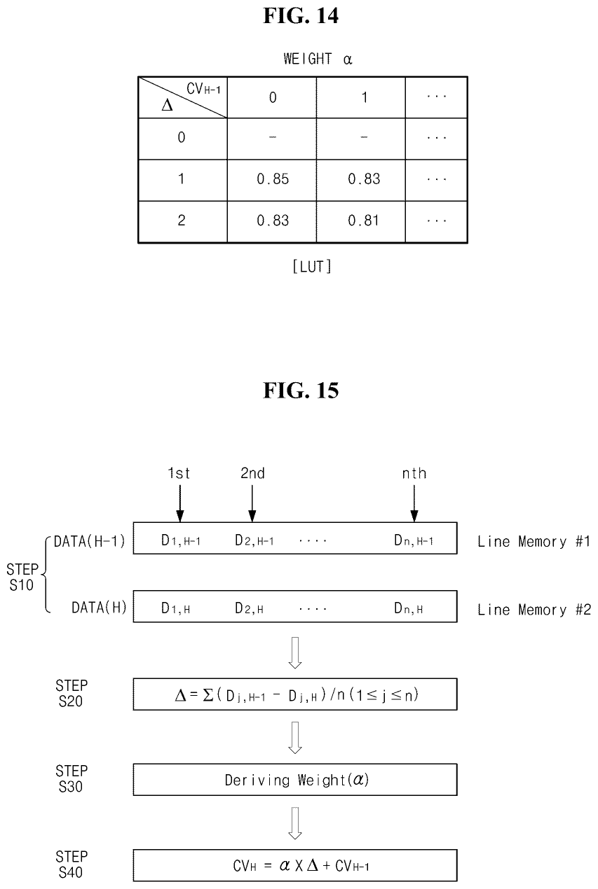

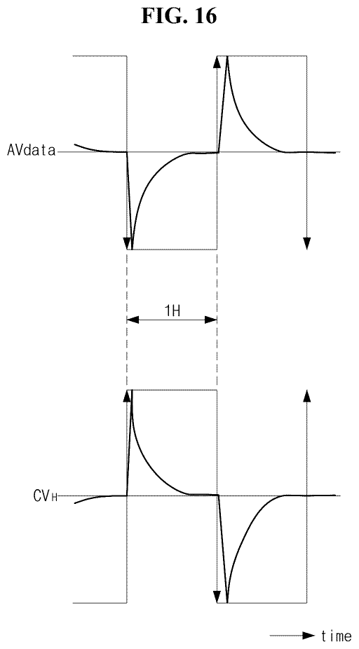

FIGS. 13 and 14 are diagrams illustrating an implementation configuration example of a compensation circuit. FIG. 15 is a flow chart illustrating an operation of a compensation circuit according to an embodiment. FIG. 16 is a diagram illustrating an example where a data voltage and a compensation voltage vary with phases opposite to each other.

Referring to FIGS. 13 to 15, a compensation circuit 300 may generate a compensation voltage CV_{H} which is to be supplied to each of a plurality of compensation units. A configuration and an operation of the compensation circuit 300 for generating the compensation voltage CV_{H}, which is to be supplied to one compensation unit, will be described below. In the following embodiment, it may be assumed that one compensation unit overlaps n number of data lines D1 to Dn.

As shown in FIG. 13, a compensation circuit 300 may include a first line memory MEM1, a second line memory MEM2, a lookup table LUT, and a compensation voltage generator ACR, so as to generate the compensation voltage CV_{H}, which is to be supplied to one compensation unit.

As shown in STEP S10 in FIG. 15, the first line memory MEM1 (or Line Memory #1) may store data voltages DATA(H−1) which are to be supplied to n number of data lines D1 to Dn, in an H−1^{st} horizontal period.

As also shown in in STEP S10 in FIG. 15, the second line memory MEM2 (or Line Memory #2) may store data voltages DATA(H) which are to be supplied to n number of data lines D1 to Dn, in an H^{th} horizontal period.

As shown in STEP S20 in FIG. 15, with reference to the first line memory MEM1 and the second line memory MEM2, the compensation voltage generator ACR may calculate an average value Δ of inverse gray levels of n number of data voltages supplied to n number of data lines D1 to Dn. In particular, the compensation voltage generator ACR may subtract n number of data voltages DATA(H) of the H^{th} horizontal period from n number of data voltages DATA(H−1) of the H−1^{st} horizontal period, and thus, may obtain n number of subtraction results representing inverse gray levels. Also, the compensation voltage generator ACR may calculate an average value Δ of the n subtraction results.

Δ=Σ(D_{j,H-1}−D_{j, H})/n (1≤J≤n) [Equation 1]

The compensation voltage generator ACR may calculate a weight α determined based on an average value Δ of inverse gray levels of n number of data voltages and a compensation voltage CV_{H-1} of the H−1^{st} horizontal period, with reference to the lookup table LUT, as shown in STEP S30 in FIG. 15. FIG. 14 illustrates several values of weight α for combinations of average value Δ and compensation voltage CV_{H-1} in lookup table LUT.

The compensation voltage generator ACR may add the compensation voltage CV_{H-1} of the H−1^{st} horizontal period to a result obtained by multiplying the average value Δ of inverse gray levels of n number of data voltages by the weight α, and thus, may finally generate a compensation voltage CV_{H} of the H^{th} horizontal period, as shown in STEP S40 in FIG. 15. This may be expressed as the following Equation 2.

CV_{H}=α*Δ+CV_{H-1} [Equation 2]

Therefore, as shown in FIG. 16, the compensation voltage CV_{H} of the H^{th} horizontal period may vary with a phase opposite to an average variation AVdata of n number of data voltages. As a result, coupling noise of a touch electrode induced by a data voltage variation may be reduced, and a voltage ripple of a cathode electrode may be removed. Also, crosstalk between a display and a touch may decrease, and thus, touch performance and display quality may be improved.

The embodiments of the invention may supply compensation electrodes with a compensation voltage for compensating for crosstalk caused by a variation of a data voltage while a touch input is being sensed, and thus, may reduce crosstalk between a display and a touch to improve touch performance and display quality.

Although certain embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A touch sensing display apparatus comprising:
a display panel including a plurality of pixels;
a display driving circuit configured to output data voltages, which are for driving the plurality of pixels, to data lines of the display panel;
a touch screen panel disposed on the display panel and including first touch electrodes arranged in a first direction in which the data lines extend, second touch electrodes arranged in a second direction intersecting the first direction, first compensation electrodes respectively adjacent to the first touch electrodes, and second compensation electrodes respectively adjacent to the second touch electrodes;
a touch circuit configured to drive the first touch electrodes and the second touch electrodes to sense a touch input applied to each of touch sensors; and
a compensation circuit configured to supply the first compensation electrodes and the second compensation electrodes with a compensation voltage for compensating for crosstalk caused by a variation of each of the data voltages while the touch input is being sensed.

2. The touch sensing display apparatus of claim 1, wherein the first compensation electrodes are surrounded by the first touch electrodes, and the second compensation electrodes are surrounded by the second touch electrodes.

3. The touch sensing display apparatus of claim 1, wherein:
the compensation voltage is an alternating current (AC) voltage which varies at a period of one horizontal period assigned for driving of pixels disposed in one pixel row; and
the compensation voltage and the data voltages vary with phases opposite to each other.

4. The touch sensing display apparatus of claim 3, wherein the compensation voltage applied to each of the first and second compensation electrodes is generated using a weighted look-up table.

5. The touch sensing display apparatus of claim 1, wherein:
the first compensation electrodes and the second compensation electrodes are divided into a plurality of compensation units separated from each other in the second direction; and
the first compensation electrodes and the second compensation electrodes included in a same compensation unit are electrically short-circuited with each other and are supplied with a same compensation voltage.

6. The touch sensing display apparatus of claim 5, wherein one of the compensation units is electrically disconnected from another compensation unit and is independently supplied with a compensation voltage.

7. The touch sensing display apparatus of claim 5, wherein:
the data lines are divided into a plurality of groups corresponding to the plurality of compensation units; and
one compensation unit included in the plurality of compensation units overlaps data lines of one group among the plurality of groups.

8. The touch sensing display apparatus of claim 7, wherein, in a predetermined time period, a variation direction of a compensation voltage supplied to the one compensation unit is opposite to an average variation direction of data voltages supplied to the data lines of the one group.

9. The touch sensing display apparatus of claim 5, wherein, in a same compensation unit,
each of the first compensation electrodes comprises a plurality of first sub compensation electrodes electrically connected to each other; and
each of the second compensation electrodes comprises a plurality of second sub compensation electrodes electrically connected to each other.

10. The touch sensing display apparatus of claim 1, wherein each of the first touch electrodes, the second touch electrodes, the first compensation electrodes, and the second compensation electrodes comprises conductive mesh patterns.

11. The touch sensing display apparatus of claim 10, further comprising a bank pattern for defining emission regions of the pixels is included in the display panel,
wherein the conductive mesh patterns avoid the emission regions and overlap the bank pattern.

12. The touch sensing display apparatus of claim 1, wherein:
the display panel further comprises a cathode electrode disposed on the data lines and connected to the pixels in common;
with respect to one of touch sensors, a parasitic capacitance between the first compensation electrode and the cathode electrode is substantially 50% or more of a parasitic capacitance between the cathode electrode and data lines overlapping a first touch electrode region; and
with respect to one of the touch sensors, a parasitic capacitance between the first compensation electrode and the first touch electrode is substantially 30% or less of a parasitic capacitance between the cathode electrode and the first touch electrode.

13. The touch sensing display apparatus of claim 12, wherein an overlap area of the first compensation electrode with the first touch electrode is smaller than an overlap area of the first touch electrode with the cathode electrode.

14. The touch sensing display apparatus of claim 1, wherein:
the display panel further comprises a cathode electrode disposed on the data lines and connected to the pixels in common;
with respect to one of touch sensors, a parasitic capacitance between the second compensation electrode and the cathode electrode is substantially 50% or more of a parasitic capacitance between the cathode electrode and data lines overlapping a second touch electrode region; and
with respect to one of the touch sensors, a parasitic capacitance between the second compensation electrode and the second touch electrode is substantially 30% or less of a parasitic capacitance between the cathode electrode and the second touch electrode.

15. The touch sensing display apparatus of claim 14, wherein an overlap area of the second compensation electrode with the second touch electrode is smaller than an overlap area of the second touch electrode with the cathode electrode.

16. The touch sensing display apparatus of claim 1, wherein:
the display panel further comprises a cathode electrode disposed on the data lines and connected to the pixels in common; and
a distance between one of the first and second touch electrodes and the cathode electrode is greater than a distance between the cathode electrode and the data line.

17. The touch sensing display apparatus of claim 16, wherein the distance between one of the first and second touch electrodes and the cathode electrode is greater than or equal to twice the distance between the cathode electrode and the data line.

18. A driving method of a touch sensing display apparatus including a display panel including a plurality of pixels, and a touch screen panel disposed on the display panel and including first touch electrodes arranged in a first direction in which data lines extend and second touch electrodes arranged in a second direction intersecting the first direction, the driving method comprising:
outputting data voltages, which are for driving the plurality of pixels, to data lines of the display panel;
driving the first touch electrodes and the second touch electrodes to sense a touch input applied to touch sensors; and
supplying a compensation voltage, which is for compensating for crosstalk caused by a variation of each of the data voltages, to first and second compensation electrodes respectively adjacent to the first and second touch electrodes while the touch input is being sensed, on the touch screen panel,
wherein the compensation voltage and the data voltage vary with phases opposite to each other.

19. The driving method of claim 18, wherein the first compensation electrodes are surrounded by the first touch electrodes, and the second compensation electrodes are surrounded by the second touch electrodes.

20. The driving method of claim 18, wherein:
the compensation voltage is an alternating current (AC) voltage which varies at a period of one horizontal period assigned for driving of pixels disposed in one pixel row

21. The driving method of claim 18, further comprising generating, by using a weighted look-up table, the compensation voltage applied to each of the first and second compensation electrodes.

22. The driving method of claim 18, wherein:
the first compensation electrodes and the second compensation electrodes are divided into a plurality of compensation units separated from each other in the second direction; and
the first compensation electrodes and the second compensation electrodes included in a same compensation unit are electrically short-circuited with each other and are supplied with a same compensation voltage.

23. The driving method of claim 22, wherein a compensation unit is electrically disconnected from another compensation unit and is independently supplied with a compensation voltage.

24. A touch sensing display apparatus comprising:
a display panel including a plurality of pixels and a plurality of data lines; and
a touch screen panel disposed on the display panel, the touch screen panel comprising:
first touch electrodes disposed above the data lines and arranged in a first direction in which the data lines extend;
second touch electrodes disposed above the data lines and arranged in a second direction intersecting the first direction; and
first additional electrodes respectively adjacent to the first touch electrodes, and second additional electrodes respectively adjacent to the second touch electrodes.

25. The touch sensing display apparatus of claim 24, wherein the first additional electrodes are surrounded by the first touch electrodes, and the second additional electrodes are surrounded by the second touch electrodes.

26. The touch sensing display apparatus of claim 24, wherein:
the display panel further comprises a cathode electrode disposed on the data lines and connected to the pixels in common;
with respect to one of touch sensors, a parasitic capacitance between the first additional electrode and the cathode electrode is substantially 50% or more of a parasitic capacitance between the cathode electrode and data lines overlapping a first touch electrode region; and
with respect to one of the touch sensors, a parasitic capacitance between the first additional electrode and the first touch electrode is substantially 30% or less of a parasitic capacitance between the cathode electrode and the first touch electrode.

27. The touch sensing display apparatus of claim 16, wherein an overlap area of the first additional electrode with the first touch electrode is smaller than an overlap area of the first touch electrode with the cathode electrode.

28. The touch sensing display apparatus of claim 24, wherein:
the display panel further comprises a cathode electrode disposed on the data lines and connected to the pixels in common;
with respect to one of touch sensors, a parasitic capacitance between the second additional electrode and the cathode electrode is substantially 50% or more of a parasitic capacitance between the cathode electrode and data lines overlapping a second touch electrode region; and
with respect to one of the touch sensors, a parasitic capacitance between the second additional electrode and the second touch electrode is substantially 30% or less of a parasitic capacitance between the cathode electrode and the second touch electrode.

29. The touch sensing display apparatus of claim 28, wherein an overlap area of the second additional electrode with the second touch electrode is smaller than an overlap area of the second touch electrode with the cathode electrode.

30. The touch sensing display apparatus of claim 24, wherein:
the display panel further comprises a cathode electrode disposed on the data lines and connected to the pixels in common; and
a distance between one of the first and second touch electrodes and the cathode electrode is greater than a distance between the cathode electrode and the data line.

31. The touch sensing display apparatus of claim 30, wherein the distance between one of the first and second touch electrodes and the cathode electrode is equal to or greater than twice the distance between the cathode electrode and the data line.

32. The touch sensing display apparatus of claim 24, wherein each of the first touch electrodes, the second touch electrodes, the first additional electrodes, and the second additional electrodes comprises conductive mesh patterns.

33. The touch sensing display apparatus of claim 32, further comprising a bank pattern for defining emission regions of the pixels is included in the display panel,
wherein the conductive mesh patterns avoid the emission regions and overlap the bank pattern.

34. The touch sensing display apparatus of claim 24, wherein each of the first and second additional electrodes comprises a plurality of sub additional electrodes electrically connected to each other.
